(19) United States
(12) Patent Application Publication
(10) Pub. No.: US 2002/0172098 A1
(43) Pub. Date: Nov. 21, 2002

(54) Analog electronic timepiece

(76) Inventor: Saburo Manaka, Chiba-shi (JP)

Correspondence Address: ADAMS & WILKS, 31st Floor, 50 Broadway, New York, NY, 10004, US

(21) Appl. No.: 10/140,719

(22) Filed: May 8, 2002

(30) Foreign Application Priority Data
May 21, 2001 (JP) 2001-151258

(51) Int. Cl. G04F 5/00

(52) U.S. Cl. 368/160

(57) ABSTRACT

To provide an analog electronic timepiece capable of driving a motor by a drive pulse having a narrow pulse width without deteriorating mechanical strength of a stator. A control circuit controls a switch in a normally closed state and switches through in a normally opened state, controls the switch to a closed state at an initial period of a drive pulse when the drive pulse is supplied to a motor via a motor driving circuit and controls the switch to a closed state during a successive period successive to the initial period. Thereby, the motor is supplied with the drive pulse having a predetermined wave height value during the initial period and the drive pulse having a wave height value smaller than the predetermined wave height value and capable of controlling to rotate the motor during the successive period, a saturation time period of a saturable portion in a stator of the motor is shortened and the motor is driven by a drive pulse having a narrow pulse width.

### BACKGROUND OF THE INVENTION

1. Field of the Invention

The present invention relates to an analog electronic timepiece for controlling to rotate a motor for driving a time hand by supplying a drive pulse from motor controlling means to the motor and indicating time by the time hand driven to rotate by the motor.

2. Description of the Prior Art

Conventionally, there has been used an analog electronic timepiece such as an analog electronic wrist watch, an analog electronic clock or the like for controlling to rotate a motor for driving a time hand by supplying a drive pulse from motor controlling means to the motor and indicating time by the time hand driven to rotate by the motor.

According to the analog electronic time piece, a step motor is used as the motor and in the step motor, an integrated type stator provided with a saturable portion is used for promoting productivity.

FIG. 4 is a schematic view for explaining operation of a general step motor conventionally used.

In FIG. 4, the step motor is provided with a stator 401, a coil 110 wound around the stator 401 and a rotor 402 of two poles arranged at inside of the stator 401. The stator 401 is formed with saturable portions 403 and 404.

Now, when a drive pulse of a rectangular wave as shown by FIG. 2B is supplied to the coil 110 and current i is supplied in an arrow mark direction of FIG. 4, magnetic flux is generated in the stator 401 in an arrow mark direction. Thereby, the saturable portions 403 and 404 are firstly saturated, thereafter, by interactive operation between a magnetic pole produced at the stator 401 and a magnetic pole of the rotor 402, the rotor 402 is rotated by 180 degrees in an arrow mark direction of FIG. 4. Thereafter, by alternately supplying current having different polarities to the coil 110, similar operation is carried out and the rotor 402 can be rotated in the arrow mark direction by 180 degrees respectively.

Meanwhile, when the drive pulse is supplied to the coil 110, only after magnetic energy produced by the coil 110 saturates the saturable portions 403 and 404 of the stator 401, the magnetic energy by the coil 110 is operated to the rotor 402 to thereby bring about a state of capable of rotating the rotor 402. Therefore, in order to rotate the rotor 402, it is necessary to firstly saturate the saturable portions 403 and 404.

FIG. 3 is a characteristic diagram showing the current flowing in the coil 110 when the drive pulse is applied to the coil 110. As shown by a characteristic 302 of FIG. 3, during a predetermined time period ST immediately after applying the drive pulse, the saturated portions 403 and 404 have not been saturated and therefore, magnetic resistance of a magnetic circuit is extremely low, as a result, rise of the current flowing in the coil 110 is retarded.

During a time period until the saturated portions 403 and 404 are saturated, the drive pulse does not contribute to rotation of the rotor 402 and therefore, there poses a problem that a rise time period until the rotor 402 starts rotating is prolonged.

Further, in order to drive to rotate the rotor 402, a constant time period of a pulse width is needed, it is necessary to include also a time width for saturating the saturable portions 403 and 404 in the pulse width and therefore, the pulse width of the drive pulse needs to prolong. Therefore, when it is necessary to drive a hand by a drive pulse having a narrow pulse width as in the case of operating the hand at high speed, there poses a problem that it is difficult to operate the hand at high speed.

Meanwhile, a saturation time period of the saturable portions 403 and 404 is proportional to volumes of the saturated portions 403 and 404 and therefore, in order to shorten a time period for saturating the saturable portions 403 and 404, it is conceivable to reduce the volumes of the saturated portions 403 and 404, however, when the volumes are reduced, mechanical strength of the stator 401 becomes deficient and there poses a problem that there is a concern of deteriorating performance of assembling the motor or deteriorating a function of the stator 401.

It is a problem of the invention to provide an analog electronic timepiece capable of driving a motor by a drive pulse having a narrow pulse width without deteriorating mechanical strength of a stator.

### SUMMARY OF THE INVENTION

According to the invention, there is provided an analog electronic timepiece characterized in that in an analog electronic timepiece for controlling to rotate a motor for driving a time hand by supplying a drive pulse from motor controlling means to the motor and indicating time by the time hand driven to rotate by the motor wherein the motor controlling means supplies a drive pulse having a predetermined wave height value to the motor during an initial period of the drive pulse and supplies a drive pulse having a wave height value smaller than the predetermined wave height value and capable of controlling to rotate the motor to the motor during a successive period successive to the initial period.

The motor controlling means supplies the drive pulse having the predetermined wave height value to the motor during the initial period of the drive pulse and supplies the drive pulse having the wave height value smaller than the predetermined wave height value and capable of controlling to rotate the motor to the motor during the successive period successive to the initial period.

In this case, there may be constructed a constitution in which the motor controlling means includes resistors connected in series with the motor and switches connected in parallel with the resistors, controls the switches to a closed state during the initial period and controls the switches to an opened state during the successive period.

Further, there maybe constructed a constitution in which the motor controlling means is constituted to include a parallel circuit connected in parallel with a plurality of series circuits of the resistors and a first switch and include a second switch connected in parallel with the parallel circuit, wherein during the initial period, the second switch is brought into a closed state and during the successive period, a specific one of the first switch previously selected in a plurality of the first switches is brought into a closed state and other of the first switches and the second switch are brought into an opened state.

Further, there maybe constructed a constitution in which the motor controlling means brings the specific one of the first switches into a normally closed state and brings the first switches other than the specific first switch to a normally opened state, wherein the second switch is brought into a closed state during the initial period and the second switch is brought into an opened state during the successive period.

### BRIEF DESCRIPTION OF THE SEVERAL VIEWS OF THE DRAWINGS

A preferred form of the present invention is illustrated in the accompanying drawings in which:

FIG. 1 is a block diagram of an analog electronic timepiece according to an embodiment of the invention;

FIGS. 2 illustrate timing charts showing a drive pulse;

FIG. 3 is a characteristic diagram showing drive current of a motor; and

FIG. 4 is a schematic view of a general step motor.

### DETAILED DESCRIPTION OF THE PREFERRED EMBODIMENTS

A detailed explanation will be given of embodiments of the invention in reference to the drawings as follows.

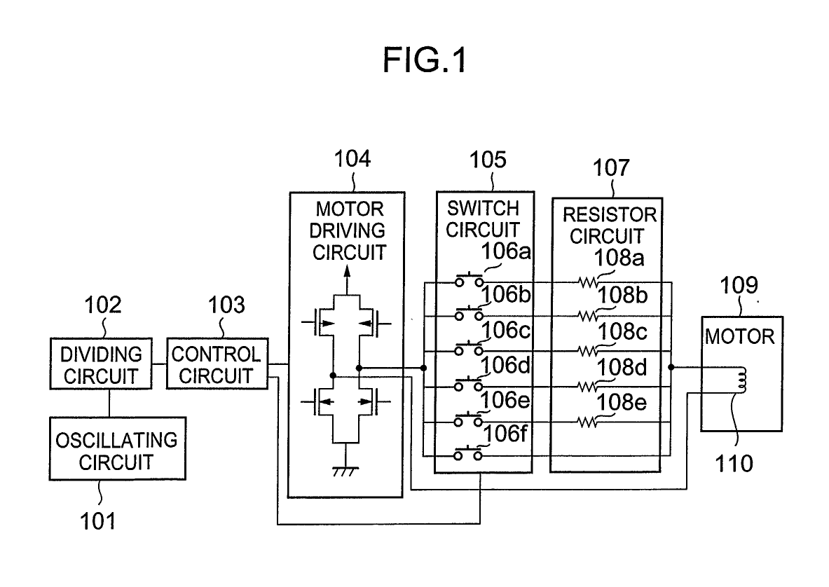

FIG. 1 is a block diagram of an analog electronic timepiece according to an embodiment of the invention, showing an example of an analog electronic wrist watch.

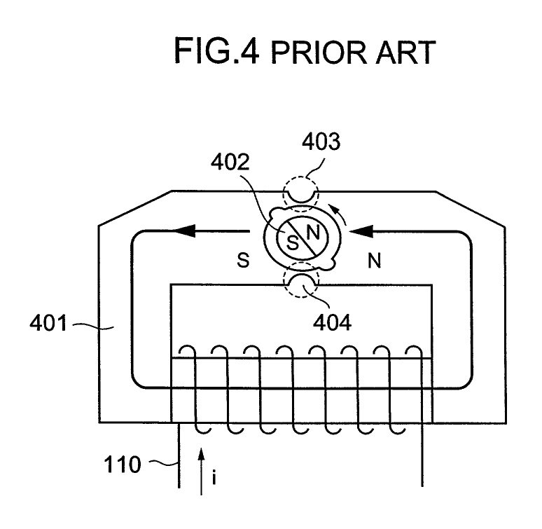

In FIG. 1, an oscillating circuit 101 is connected to an input portion of a control circuit 103 via a dividing circuit 102. An output portion of the control circuit 103 is connected to a motor 109 for driving a time hand via a motor driving circuit 104, a switch circuit 105 and a resistor circuit 107. The motor 109 is a step motor having a constitution shown in FIG. 4.

The dividing circuit 102 divides a reference clock signal from the oscillating circuit 101 and outputs a second signal and a minute signal to the control circuit 103. The control circuit 103 controls to open/close opening/closing switches 106a through 106f included in the switch circuit 105 based on the second signal and the minute signal, further, controls to fast feed the motor 109, controls to stop to drive the motor 109 or the like in response to operation of an operating portion, not illustrated.

The motor driving circuit 104 is a well-known motor driving circuit having a constitution constituted by two pieces of P-channel MOS transistors and two pieces of N-channel MOS transistors and the coil of the motor is connected between common drains.

The switch circuit 105 is provided with a plurality of the switches 106a through 106f connected in parallel and terminals of the respective switches 106a through 106f on one side are connected in parallel with one of the common drains of the motor driving circuit 104. The respective switches 106a through 106f are provided at inside of an integrated circuit (not illustrated) and are controlled to open and close by control by the control circuit 103. The respective switches 106a through 106e are for selecting resistors 108a through 108e used for setting a wave height value of a successive period of the drive pulse and the control circuit 103 is previously set with information of which of the switches 106a through 106e is controlled to an opened state or a closed state in accordance with a characteristic of the motor 109.

The wave height value of the drive pulse in the successive period is set to a wave height value smaller than a predetermined wave height value in an initial period and sufficient for normally driving the motor 109.

Further, the switch 106f included in the switch circuit 105 is for generating a drive pulse having a predetermined wave height value during the initial period of the drive pulse. A wave height value of the drive pulse during the initial period is set to a wave height value larger than the predetermined wave height value in the successive period, further, sufficient for driving the motor 109.

The switch 106f is connected in parallel with a parallel circuit connected in parallel with a plurality of series circuits of the switches 106a through 106e and the resistors 108a through 108e. In this case, the switches 106a through 106e constitute a first switch and the switch 106f constitutes a second switch.

The resistor circuit 107 is provided with a plurality of the resistors 108a through 108e connected in parallel and terminals of the respective resistors 108a through 108e on one side are connected in series with terminals of the respectively corresponding switches 106 through 106e on other side at inside of the switch circuit 105. Other terminals of the respective resistors 108a through 108e are respectively connected in parallel with one terminal of the coil 110 for driving the motor 109.

The respective resistors 108a through 108e are for setting the wave-height value of the successive period in the drive pulse and resistance values of the respective resistors 108a through 108e are selected to values different from each other. Since a necessary wave height value differs for the respective motor 109 used, there are previously prepared the plurality of resistors 108a through 108e having different resistance values, there are previously selected resistors used at a design stage or a fabrication stage in accordance with the characteristic of the motor 109 and in operating the electronic timepiece, as described later, the wave height value of the successive period becomes the predetermined value by using the previously selected resistors. Thereby, a circuit constitution can be made common even when the characteristic of the used motor 109 differs by a kind thereof. Further, the respective resistors 108a through 108e are provided at inside of the integrated circuit.

Other terminal of the coil 110 is connected to other of the common drains of the motor driving circuit 104. The oscillating circuit 101, the dividing circuit 102, the control circuit 103, the motor driving circuit 104, the switch circuit 105 and the resistor circuit 107 constitute motor controlling means.

An explanation will be given of operation of the embodiment according to the invention in reference to FIG. 1 through FIG. 3 as follows. Further, an explanation will be given such that the resistor 108a is used for the successive period of the drive pulse. In this case, by control of the control circuit 104, the specific switch 106a is brought into a normally closed state and the switches 106b through 106e other than the specific switch are brought into a state of being controlled to a normally opened state.

Under the state, the dividing circuit 102 divides the reference clock signal from the oscillating circuit 101 and outputs a time signal of a second signal or the like to the control circuit 103. The control circuit 103 outputs the time signal to the motor driving circuit 104. Thereby, the motor driving circuit 104 outputs a drive pulse of a rectangular wave to the switch circuit 105. Further, in this case, the motor driving circuit 104 is previously set to output a drive pulse of a rectangular wave having a predetermined wave height value higher than voltage necessary for normally driving the motor.

Simultaneously therewith, the control circuit 103 controls the switch circuit 105 in synchronism with supply of the time signal to the motor driving circuit 104, brings the switch 106f into a closed state during a previously set time period (initial period st) and thereafter controls to bring the switch 106f into an opened state again during the successive period.

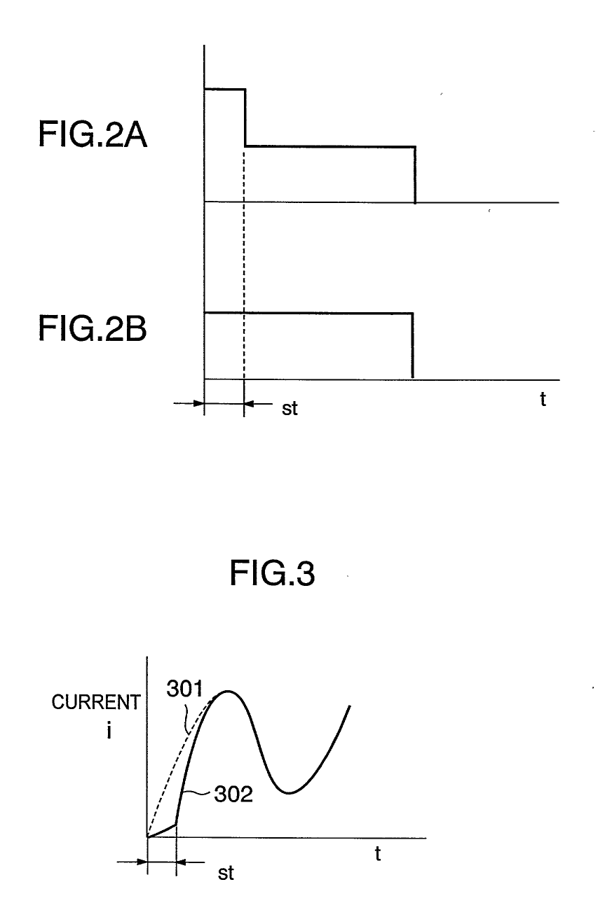

Thereby, the motor driving circuit 104 and the motor 109 are shortcircuited during the initial period and connected via the resistor 108a during the successive period. Therefore, as shown by FIG. 2A, the coil 110 of the motor 109 is supplied with a drive pulse having a predetermined wave height value larger than voltage necessary for driving the motor 109 during the initial period (st) and is supplied with a drive pulse of a wave height value smaller than the predetermined wave height value and capable of controlling to rotate the motor 109 in accordance with the characteristic of the motor 109.

When the motor 109 is supplied with the drive pulse of FIG. 2A, as shown by a characteristic 301 of FIG. 3, large current flows in the coil 110 during the initial period and normal drive current flows therein during the successive period. Thereby, the saturable portions 403 and 404 of the stator 401 are saturated in a short period of time and the rotor 402 can be rotated swiftly. Therefore, the motor 109 can be controlled to rotate by using a drive pulse having a narrow pulse width and the hand can be operated at high speed when the second hand is returned to the 0 o'clock position.

As described above, according to the embodiment of the invention, the analog electronic timepiece is particularly constituted such that in an analog electronic timepiece for controlling to rotate the motor 109 for driving a time hand by supplying a drive pulse from motor controlling means to the motor 109 and indicating time by the time hand driven to rotate by the motor 109 wherein the motor controlling means supplies a drive pulse having a predetermined wave height value to the motor 109 during an initial period of the drive pulse and supplies a drive pulse having a wave height value smaller than the predetermined wave height value and capable of controlling to rotate the motor to the motor 109 during a successive period successive to the initial period.

Further, the motor controlling means includes the resistors 108a through 108e connected in series with the motor 109 and the switch 106f connected in parallel with the resistors 108a through 108e, controls the switch 106f to a closed state during the initial period and controls the switch 106f to an opened state during the successive period.

Therefore, a saturation time period for saturating the saturable portions 403 and 404 of the stator 401 can be shortened and therefore, the embodiment can be driven by a drive pulse having a narrow pulse width. Therefore, since a time period of driving the motor 109 for driving the time hand can be shortened, the hand can be operated at high speed.

Further, volumes of the saturated portions 403 and 404 of the stator 401 can be increased and therefore, mechanical strength of the stator 401 can be promoted and mass production performance of the electronic timepiece can be promoted.

Further, the saturated portions 403 and 404 can be saturated swiftly and therefore, the efficiency can be promoted and low power consumption can be achieved.

Further, although according to the embodiment, the switch circuit 105 and the resistor circuit 107 are arranged in the integrated circuit and all the switches 106a through 106f included in the switch circuit 105 are controlled to open and close by the control circuit 103, the resistors 108a through 108e may be connected to a wiring pattern of a circuit board and anyone of the resistors 108a through 108e used may previously be selected by cutting the wiring pattern in accordance with a kind of an electronic timepiece.

Further, the resistors 108a through 108e are not necessarily needed to form at inside of the integrated circuit but may be arranged at the circuit board.

Further, although according to the embodiment, an explanation has been given of an example of an electric wrist watch, the embodiment is applicable to other analog electronic timepiece of a clock or the like.

According to the invention, a motor for driving a time hand can be driven by a drive pulse having a narrow pulse width without deteriorating mechanical strength of a stator. Therefore, a hand can be operated at high speed.

What is claimed is

1. An analog electronic timepiece characterized in that in an analog electronic timepiece for controlling to rotate a motor for driving a time hand by supplying a drive pulse from motor controlling means to the motor and indicating time by the time hand driven to rotate by the motor:
wherein the motor controlling means supplies a drive pulse having a predetermined wave height value to the motor during an initial period of the drive pulse and supplies a drive pulse having a wave height value smaller than the predetermined wave height value and capable of controlling to rotate the motor to the motor during a successive period successive to the initial period.

2. The analog electronic timepiece according to claim 1, wherein the motor controlling means includes resistors connected in series with the motor and switches connected in parallel with the resistors, controls the switches to a closed state during the initial period and controls the switches to an opened state during the successive period.

3. The analog electronic timepiece according to claim 1, wherein the motor controlling means is constituted to include a parallel circuit connected in parallel with a plurality of series circuits of the resistors and a first switch and include a second switch connected in parallel with the parallel circuit;
wherein during the initial period, the second switch is brought into a closed state and during the successive period, a specific one of the first switch previously selected in a plurality of the first switches is brought into a closed state and other of the first switches and the second switch are brought into an opened state.

4. The analog electric timepiece according to claim 3, wherein the motor controlling means brings the specific one of the first switches into a normally closed state and brings the first switches other than the specific first switch to a normally opened state;
wherein the second switch is brought into a closed state during the initial period and the second switch is brought into an opened state during the successive period.
